(19) United States
(12) Patent Application Publication
(10) Pub. No.: US 2008/0254410 A1
(43) Pub. Date: Oct. 16, 2008

(54) ONE-HANDLE ORAL EXTRACTION DEVICE

(76) Inventor: Richard Golden, Detroit, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 12/026,180

(22) Filed: Feb. 5, 2008

Related U.S. Application Data
(60) Provisional application No. 60/888,261, filed on Feb. 5, 2007.

(51) Int. Cl. A61C 3/14

(52) U.S. Cl. 433/159

(57) ABSTRACT

The present invention relates generally to an extraction or pliers type device, such as typically utilized by a dentist or oral surgeon. More specifically, the present invention teaches an extraction device exhibiting a single handle terminating at a forward location in one of a hooked engaging portion or a pad support portion. A linearly translatable pad support portion or hook engaging portion is linearly supported along an extending neck of the elongated handle, in proximity to the hooked engaging portion, and for quickly and efficiently enabling a dental professional to remove a patient's tooth or root tip.

### CROSS-REFERENCE TO RELATED APPLICATIONS

This Application is a Non-Prov of Prov (35 USC 119(e)) application 60/888,261 filed on Feb. 5, 2007 and entitled One-Handle Oral Extraction Device.

### FIELD OF THE INVENTION

The present invention relates generally to an extraction device, such as typically utilized by a dentist or oral surgeon. More specifically, the present invention teaches an extraction device exhibiting a single handle body terminating at an end location in a hooked engaging portion. A pad support portion is secured to an intermediate location of the body and is linearly adjustable in directions both towards and away from the hooked engaging portion. In use, the device is manipulated such that the hook portion is first positioned along an inward (lingual) facing surface of a tooth to be removed (such as at or just below the gum line). The pad support is further adjusted (or readjusted) such that it abuts an opposite and outward facing (buccal) surface of the selected tooth, following which the handle is manipulated by the user (dentist or oral surgeon) by rotating downwardly (for a lower jaw tooth removal) or upwardly (for an upper jaw tooth removal), for quickly and efficiently enabling a dental professional to remove a patient's tooth or root tip.

### BACKGROUND OF THE INVENTION

Dental plier designs are known in the art and which provide the ability to apply significant leverage to a patient's mouth in the removal of teeth and root tips. A first example of such a plier design is set forth in U.S. Pat. No. 6,910,890, issued to Golden, and which teaches a dental plier appliance and associated method for removing teeth from a patient's gum line and bone. First and second handles are provided, each including a user grasping portion. The first handle terminates in an arcuately extending jaw exhibiting a substantially pointed end, the second handle terminates in an opposing and offset support exhibiting a support surface with an ergonomic configuration substantially matching that of the patient's gum line. Upon applying the support along a selected location below the gum line, and further aligning the jaw in abutting fashion against an inwardly facing side of a tooth and a penetrating distance beneath the gum line, the offset support defines a center point of rotation proximate to an edge location of the gum line and bone. The handles are subsequently rotated in an outward fashion away from the patient's gum line to forcibly dislodge the tooth from the patient's gum line and bone.

Beyond the two-handled design set forth in the U.S. Pat. No. 6,910,890 patent, a further example of a single handled tooth extractor is disclosed in U.S. Pat. No. 4,230,454, issued to Lococo, and which teaches a dentistry kit for tooth extraction consisting of a vise-type grip member having a joint member engaged by a forked end of a lever whose convexly curved fulcrum surface rests against a planar base plate located on teeth adjacent to the extracted tooth. The connection between the grip member and the lever is thus of the type generally resembling an angularly loose swivel joint. The grip member further includes two hemispherical tips, for engaging correspondingly shaped indentations drilled in the buccal and lingual sides of the tooth and which, upon being connected to the lever portion of the handle, establishing a pull force which is changed by displacing the point of contact between the fulcrum and the base plate.

### SUMMARY OF THE INVENTION

The present invention discloses a single handle extraction device for removing teeth and root tips and exhibiting a single handle body terminating at an end location in a hooked (or beak shaped) engaging portion. A pad support portion is secured to an intermediate location of the body and is linearly adjustable in directions both towards and away from the hooked engaging portion.

In a first variant, a pin and slot arrangement is defined between an attachable pad support and the main handle, this permitting the pad support to be repositionable in linear directions along the handle and over a range corresponding to the length of the slot. A sub-variant includes pluralities of opposing teeth defined between an integrally formed mounting portion associated with the pad support and a subset length of the handle, this providing additional non-slip protection beyond that created by the fulcrum bending motion of the tool once the hooked engaging portion and pad support are pre-positioned.

In a second variant, the pad support is reconfigured such that the integral mounting portion associated with the movable pad support is redesigned as a substantially collar shaped mounting component slidably engageable over a transitioning neck portion of the tool. An inwardly (e.g. spring) biased pin is mounted to the collar shaped component and seats within a selected and linearly spaced recessed mounting location for defining a spatial arrangement of the pad relative to the hooked engaging portion.

In a third variant, the relationship between the hooked engaging portion and the pad support is reversed, and such that the pad support is integrally formed with and extends from an upper end of the single handle. The beak shaped engaging portion in turn includes an elongated stem, this coaxially seating in linearly repositionable fashion within an interior channel defined in a fixed collar portion of the handle.

In either the first or second variants, the device is manipulated such that the hook portion is first positioned along an inward (lingual) facing surface of a tooth to be removed (such as at or just below the gum line). The pad support is then adjusted (or readjusted) such that it abuts an opposite and outward facing (buccal) surface of the selected tooth, following which the handle is manipulated by the user (dentist or oral surgeon) by rotating downwardly (for a lower jaw tooth removal) or upwardly (for an upper jaw tooth removal), for quickly and efficiently enabling a dental professional to remove a patient's tooth or root tip. In the third variant, this protocol is reversed with the pad support first positioned along a buccal surface of a selected tooth, following which the beak shaped hook is repositioned along a lingual surface and in order to define an optimal engagement, arrangement for lever action removal of the desired tooth or fragmented root tip.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a plan view illustration of a single handle dental extraction device according to a first preferred embodiment of the present invention and exhibiting a pin and slot arrangement is defined between an attachable pad support and the main handle, this permitting the pad support to be repositionable in linear directions along the handle and over a range corresponding to the length of the slot;

FIG. 2 is a perspective view of the dental extraction device of FIG. 1 and illustrating the range of linear displacement of the pad support;

FIG. 3 is a partial exploded illustration of dental extraction device of FIG. 1;

FIG. 4 is a sectional perspective of a sub-variant of FIG. 1 and exhibiting pluralities of opposing teeth defined between both the integrally formed mounting portion associated with the movable pad support, as well as a subset length of the handle and in order to provide additional non-slip protection beyond that created by the fulcrum bending motion of the tool once the hooked engaging portion and pad support are pre-positioned in a desired spatial arrangement;

FIG. 5 is a partial exploded illustration of the dental extraction device of FIG. 4;

FIG. 6 is a partial perspective of a pad support reconfigured such that the integral mounting portion associated with the movable pad support is redesigned as a substantially collar shaped mounting component slidably engageable over a transitioning stem portion of the tool;

FIG. 7 is a plan cutaway view illustrating the adjustable nature of the inwardly (e.g. spring) biased pin being mounted to the collar shaped component and seating within a selected and linearly spaced recessed mounting location for defining a spatial arrangement of the pad relative to the hooked engaging portion;

FIG. 8 is a plan view of a third variant in which the pad support is integrally formed with and extends from an upper end of the single handle, a beak shaped engaging portion in turn including an elongated stem which is coaxially seated in linearly repositionable fashion within an interior channel defined in a fixed collar portion of the handle;

FIG. 9 is an illustration similar to FIG. 8 and further illustrating linearly adjustable engaging beak in a most fully retracted position;

FIG. 10 is a cutaway view taken along line 10-10 of FIG. 8 and illustrating from a lop plan direction the relationship between the beak shaped stem and surrounding collar;

FIG. 11 is an environmental illustration of the extraction device of FIG. 8 arranged in a pre-removal positioned relative to an upper bridge defined tooth; and

FIG. 12 is a cutaway view taken along line 12-12 of FIG. 11 and showing an optional variant of the beak shaped stem exhibiting exteriorly serrated surfaces for providing additional non-slip protection beyond that created by the fulcrum bending motion of the tool.

### DETAILED DESCRIPTION OF THE PREFERRED EMBODIMENTS

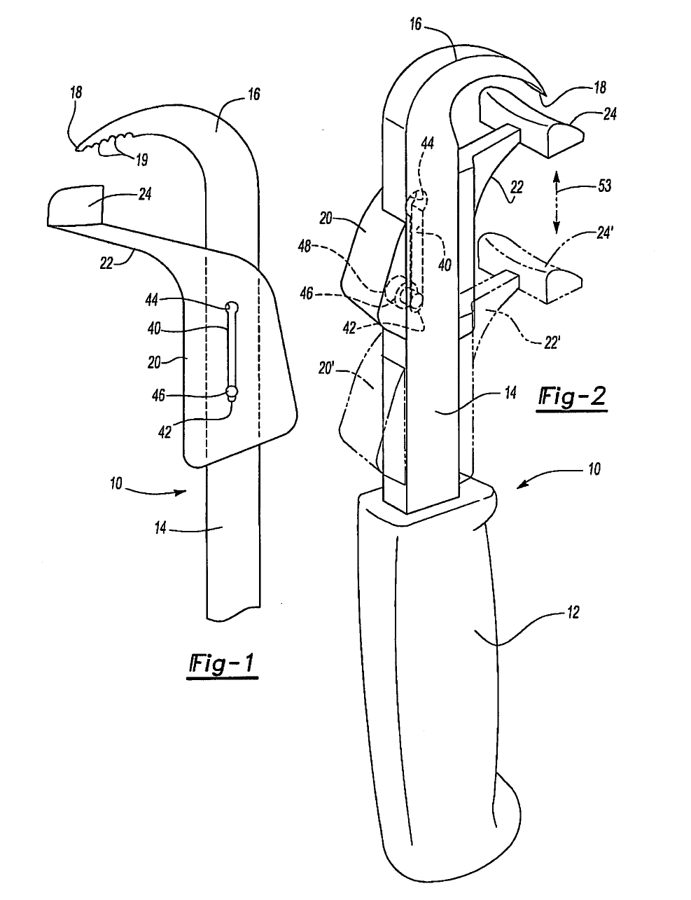

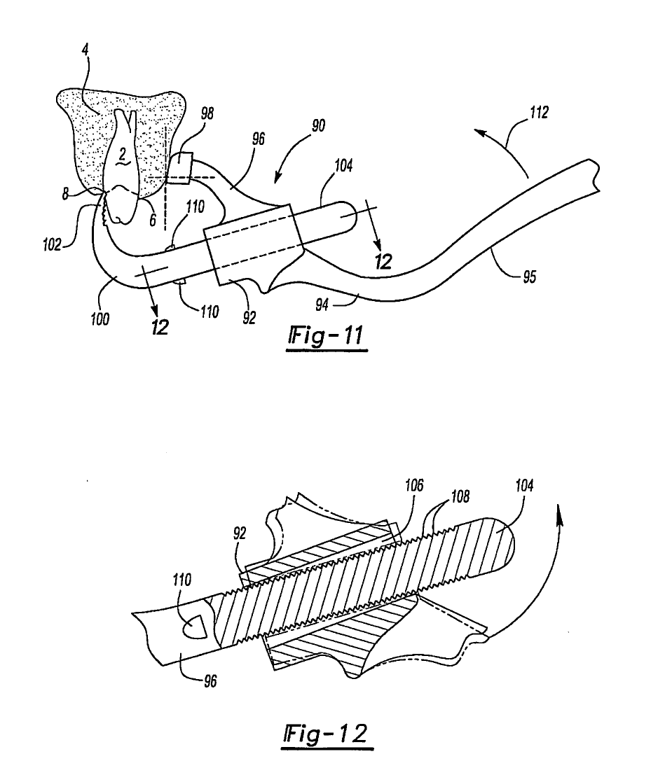

Referring now to FIGS. 1 and 2, respective plan and perspective view illustrations are shown at 10 of a single handle dental extraction device according to a first preferred embodiment of the present invention. As previously described, the present invention discloses a single handle extraction device for removing teeth and root tips, see at 2 in FIG. 11 and which is anchored within a lower or (as shown) upper bridge 4, the tooth 2 further illustrating respective buccal (outward) 6 and lingual (inward) 8 facing surfaces.

The extraction device exhibits an elongated grasping portion in the form of a single handle 12 of desired and non-limiting configuration and which can further exhibit any desired ergonomic or other configuration. In particular, the handle can be designed for the removal of either upper and/or lower teeth or root tips, the associated handle configuration further contemplating specialized reconfigurations for addressing such as upper right, upper left, lower right, lower left positioned teeth, as well as general left hand or right hand variants according to the preference of the user.

An extending stem is illustrated at 14 projecting in generally linear direction from the handle 12 and terminating at an upper end location in a hooked (or beak shaped) engaging portion 16, in turn terminating in a generally downwardly angled and pointed tip 18. As further shown in FIG. 1, a plurality of serrations 20 are defined along an underside of the engaging portion in proximity to the pointed tip 18 and, as will be further described in reference to the further variant shown in the environmental view of FIG. 11, can assist in engaging the pointed tip 18 with the lingual 8 associated surface of the tooth 6, such as again in proximity to the gum line established with the bridge 4.

The handle 12 and stem 14 can additionally incorporate any form of undulations, fenestrations, knurling or other type of gripping surface in order to provide more sure gripping when being manipulated by a user. The handle 12 and/or stem 14 may further adopt a desired angle or taper in order to optimize the leveraging effect when applied by the dental/oral professional and as will be further described.

The stem 14 (again with integrally formed engaging portion 16 and pointed tip 18) is further constructed form such as a high grade stainless steel material (such as easily sanitized), it being further understood that other materials including synthetics or composites (further not limited to plastics, carbon fiber, or the like) can be incorporated without departing from the scope of the invention.

A pad support portion (otherwise known as a bumper support) is illustrated as including a body 20 engageable with the extending stem 14, and from which extends an angled neck 22 terminating in generally economically surface configured and width wise extending bridge support surface 24 (this as again shown in FIG. 11 supporting against a surface of the patient bridge 4 associated with the buccal side of the mouth). As illustrated in each of FIGS. 1-3 (and further best shown in FIG. 3), the body 20 of the engageable pad support portion 20 includes first 26 and second 28 generally heightwise extending portions, these further defining inwardly and opposingly facing surfaces 30 and 32, respectively defining a recessed extending channel and which seats over and abuts opposite front and rear surfaces, 34 and 36 associated with the stem 14.

The stem 14 and inner defined channel of the pad support body 20 can both exhibit a generally rectangular (three sided with fourth open faced) configuration, it also being contemplated that a cross sectional rounded, oval or other configuration is also contemplated within the scope of the invention. A recessed inner surface 38 (again best shown in FIG. 3) of the channel defined pad support portion interior further exhibits a lengthwise extending slot 40 terminating in a rounded lower end 42 and an enlarged keyhole upper end 44.

A pin 46 is provided and engages through a location associated with the slot 40 in order to secure the pad support portion 20 to the stem 14. Although not clearly shown, it is envisioned that such as a spring biased seating pin or other mechanism may be employed for engaging the pin 46 and its associated enlarged head 48 (initially through the keyhole upper end 44 and then in translating fashion along the slot 40) and further extending such as into a recess aperture (such as shown at 50 in the partial cutaway illustration of the stem 14 in FIG. 3) and which may be formed widthwise through the stem 14.

Along these lines, it is understood that the pin 46 can be fixedly mounted in extending fashion through the stem aperture 50 and selectively displaced in a direction along cross wise axis 52 (again FIG. 3) to selectively unseat and reseat relative to the slot 40 and so that the pad support portion 20 is secured to an intermediate location of the stem 14 portion of the handle, and is linearly adjustable in directions both towards and away from the hooked engaging portion 16 along a range generally corresponding to the length of the slot 40. Reference is again made to FIG. 2, and which illustrates a range of linear displacement (see arrow 53) of the pad support, shown again in solid at 20 in an uppermost displaced position, and further by virtue of the phantom representation of the pad support 20′ with neck 22′ and width wise extending bridge support surface 24, this representing the pad support in respective uppermost and lowermost defined positions corresponding to the length of the slot.

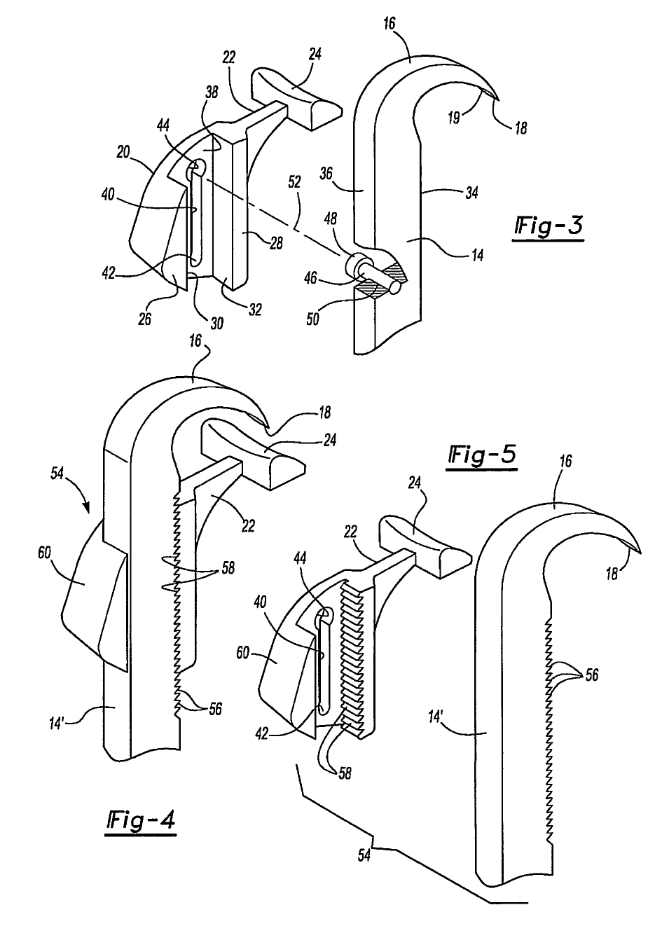

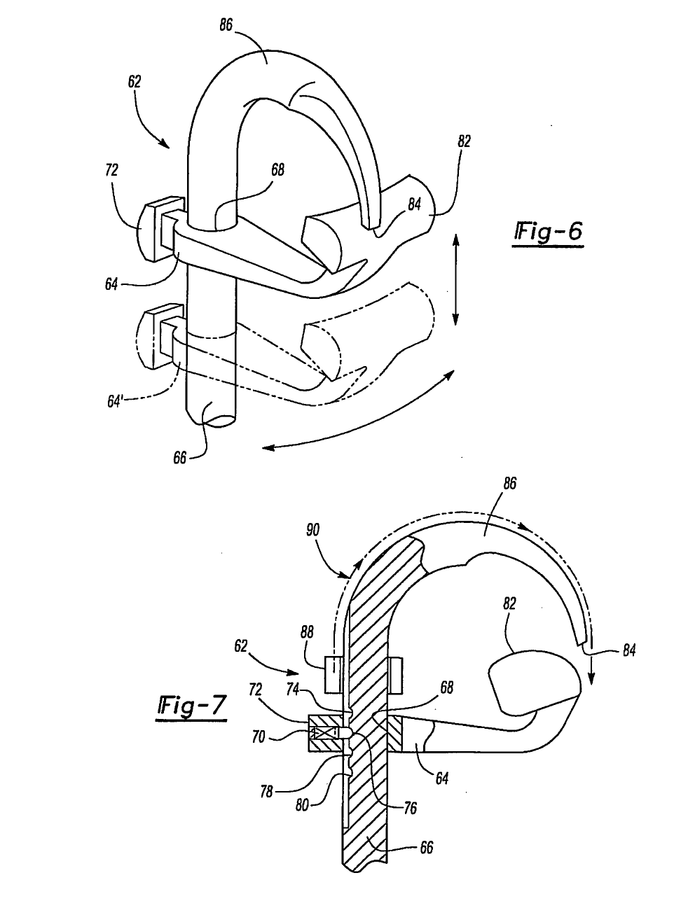

Referring now to FIGS. 4 and 5, a sectional and partial exploded perspectives are generally referenced at 54 of a sub-variant of extraction device 10 of FIG. 1 and exhibiting pluralities of opposing teeth, see respectively at 56 and 58, defined between a reconfigured front surface 56 of a revised stem 14′, as well as at 58 associated with a reconfigured facing surface 32′ defining in part the linearly extending channel also illustrated in FIG. 3 and in reference to a modified pad support portion 60. The provision of the interengaging teeth or serrations 56 and 58 assist in providing additional non-slip protection beyond that nominally created by the fulcrum bending motion of the pad support portion 60 against the stem 14′, and once the hooked engaging portion 16 and pad support are pre-positioned in a desired spatial arrangement. Otherwise, the remaining structure illustrated in FIGS. 5 and 6 is identical to that described in the first variant of FIGS. 1-3 and, accordingly, is identically numbered.

Referring now to FIGS. 6 and 7, respective partial perspective and plan cutaway views arc shown of another sub-variant, at 62, of the extraction tool. As shown, a pad support portion is reconfigured at 64 for mounting about such as a circular cross section stem 66 associated with the one-piece handle, and further such that the integral mounting portion associated with the movable pad support is redesigned as a substantially collar shaped mounting component, see inner open circular profile 68, slidably engageable over a transitioning portion of the stem 66 of the tool.

As further illustrated in the plan cutaway view of FIG. 7, linear adjustability of the pad support portion 64 is facilitated in one variant through the incorporation of an inwardly (e.g. spring) biased pin 70, this being mounted to the collar shaped component and such that an associated and protruding tab 72 can be rearwardly displaced in order to selectively seat the pin 70 within a selected and linearly spaced recessed mounting location, see at 74, 76, 78 and 80, at spaced locations along a linear extending recess in the stem 66 and defining a spatial arrangement of the pad support 64, see crosswise extending support surface 82, relative to a pointed tip 84 of a hook engaging portion 86. FIG. 6 also illustrates the adjustability aspect of the pad support (see also phantom displaced position 64′) relative to the modified circular cross sectional shaped stem 66.

Additionally, FIG. 7 shows a secondary collar, see at 88, which can be secured to the stem 66 at a location above the nominal adjusting positions of the collar shaped component 64, and further so that the secondary collar 88 can be selectively removable, see along arrow 90, from the upper end of the hook engaging portion 86. The secondary collar 88 can likewise exhibit such as spring biased and seating pin construction and to function as independently movable relative to the collar portion associated with the pad support 64 with respect to the individual seating locations 74, 76, 78 and 80, and so that the collar 88 can be fixedly located in abutting fashion upon a top of the collar engaging portion 68 of the pad support 64 to lend additional anti-rotating and anti-bending support (such as about a linear extending axis running through a centerline of the stem 66) to the collar connection 68 defined between the pad support 64 and the circular stem 66.

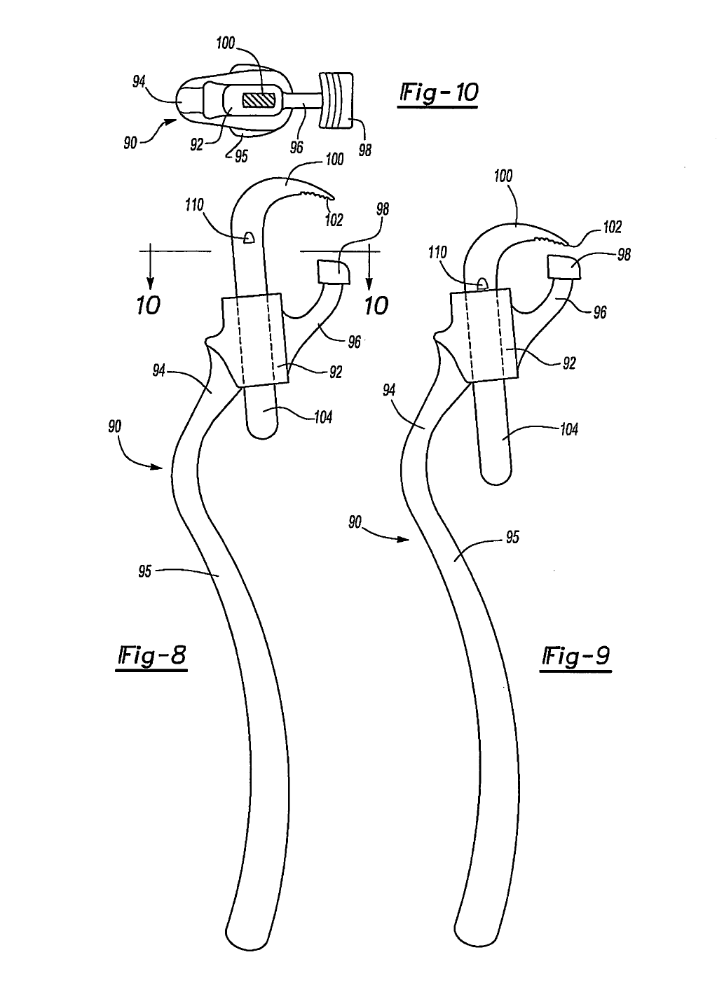

Referring further to FIGS. 8-12, a series of plan, sectional and cutaway views are shown of a single handled extraction tool according to a yet further variant 90 (see in particular FIGS. 8, 9 and 11). Of note, the variant 90 is a general reversal of the variants of FIGS. 1-5 and 6-7, in that a pad support is integrally formed with and extends from an upper end of the single handle stem 94. The pad support includes both an annular integrally positioned collar 92 relative to the stem 94 in turn integrally formed with a handle 95, and from the stem 94 extends a neck 96 terminating in a similarly crosswise extending and (ergonomically) configured pad support surface 98.

A beak shaped engaging portion 100 is further provided with a pointed and (in one instance underside serrated) tip 102. The beak portion 100 is integrally formed with and terminates into a substantially linear elongated stem 104, this in turn being coaxially seated in linearly repositionable fashion within an interior channel 106 (see cutaway of FIG. 12) defined in the fixed collar 92 of the handle defining stem 96.

A plurality of exteriorly serrated surfaces 108 are exhibited upon the interfiling stem 104, these selectively engaging inner end wall locations associated with the integrally formed collar 92, and for providing additional non-slip protection beyond that created by the fulcrum bending motion of the beak engaging portion 100 of the oral extraction device or tool. A pair of wing tabs 110 are integrally defined on such as oppositely arranged surfaces of the engaging portion, and such as approximate a transitioning boundary between the upper arcuate beak 100 and the elongate and circular cross sectional stem 104. The purpose of the tabs 110 is to define a maximum retracting position of the beak engaging portion (see FIG. 9) relative to the integrally formed collar 92, this further preventing undesirable slippage of the pointed edge 302 of the beak engaging portion 100, and following either pre or post positioning of the pad support 98 as shown in FIG. 11.

In use, and according to either the first (FIGS. 1-5) or second (FIGS. 6, 7) variants, the device is manipulated such that the hook portion is first positioned along an inward (lingual) facing surface of a tooth to be removed (such as at or just below the gum line). The pad support is then adjusted (or readjusted) such that it abuts an opposite and outward facing (buccal) surface of the selected tooth, following which the handle is manipulated by the user (dentist or oral surgeon) by rotating downwardly (for a lower jaw tooth removal) or upwardly (for an upper jaw tooth removal and as is representatively shown by arrow 112 in FIG. 11), for quickly and efficiently enabling a dental professional to remove a patient's tooth or root. tip. In the third variant (FIGS. 8-12), this protocol can be optionally reversed, with the pad support first positioned such as along a buccal surface of a selected tooth, following which the beak shaped hook is repositioned along a lingual surface and in order to define an optimal engagement arrangement for lever action removal of the desired tooth or fragmented root tip.

The re-adjustability aspects of the present invention, combined into a single handled dental lever-type extraction tool, can additionally facilitate ease of readjustment in mid-extraction of teeth or root lips, such usually being required to finesse the engagement locations against the tooth or root tip, and following an initial rotating displacement but prior to a completed removal. The ability to easily readjust the instrument during mid-extraction provides the user with the increased ability to quickly and more painlessly remove the tooth, without damage to the same or the surrounding bridge or gum line, than is possible with more conventional tools which require more effort in the way of manipulation or the requirement that multiple tools be employed in the removal of the tooth/root tip (this again increasing the effort and lime for removing).

It is also envisioned that the hook and pad support can be reversed in position, such that the pad can contact the lingual surface, with the hook portion engaging a tooth location associated with the buccal surface and by which inward rotation of the device results in tooth/root tip removal.

The one-handled device according to the present design further accomplishes the objective of avoiding the heretofore requirement of the dental professional having to leverage two handles during the extraction procedure. An undesirable consequence of this requirement is the amount of foree and pressure applied against the tooth by a conventional two handled plier design, this resulting in both damage to the tooth and the surrounding areas of the patient's gum line and possibly bridge, as well as the increased amount of pain inflicted upon the patient, and by virtue of a non-optimal extraction protocol being implemented during tooth removal.

Having described our invention, other and additional preferred embodiments will become apparent to those skilled in the art to which it pertains, and without deviating from the scope of the appended claims.

We claim:

1. An oral extraction device, comprising:
an elongated grasping portion terminating in a hook portion for engaging a first surface associated with at least one of a tooth and a root tip; and
a pad support repositionable relative to said hook portion and for engaging a second surface associated with a dental bridge supporting said tooth or root tip;
said extraction device adapted for one-handed positioned and repositioning by a user prior to and during extraction of the tooth or root tip.

2. The device according to claim 1, said grasping portion further comprising a handle from which extends a stem communicating with said hook portion and in turn terminating in a downwardly angled and pointed tip.

3. The device according to claim 2, further comprising a plurality of serrations defined along an underside of said tip.

4. The device according to claim 2, said pad support further comprising a portion engageable with said stem and from which extends an angled neck terminating in generally ergonomically surface configured and width wise extending bridge support surface.

5. The device according to claim 4, said pad support portion further comprising first and second generally heightwise extending portions in turn defining inwardly and opposingly facing surfaces and between which is established a recessed extending channel seating over and abutting opposite front and rear surfaces associated with said stem.

6. The device according to claim 5, said pad support portion further comprising a recessed surface defining in part said extending channel and exhibiting a lengthwise extending slot terminating in a rounded lower end and an enlarged keyhole upper end.

7. The device according to claim 6, further comprising a pin engaging through a location associated with said slot in order to secure the pad support portion to said stem.

8. The device according to claim 5, further comprising pluralities of opposing and interengaging serrations defined between said front surface of said stem and a selected one of said height extending portions of said pad support portion, said serrations providing additional non-slip protection beyond that nominally created by a fulcrum bending motion of said pad support portion against said stem.

9. The device according to claim 4, said pad support portion further comprising a collar shaped and interiorly open mounting component slidably engageable over said stem, said collar shaped component being linearly repositioned at locations along said stem.

10. The device according to claim 9, further comprising a spring biased pin mounted to said collar shaped component, an associated and protruding tab capable of being displaced to selectively seat and unseat said pin with respect to a selected and linearly spaced recessed mounting location defined at spaced locations along said stem.

11. The device according to claim 10, further comprising a secondary collar secured to said stem proximate a nominal adjusting position of said collar shaped component.

12. The device according to claim 1, said grasping portion further including a handle transitioning into a stem, and from which extends a neck terminating in a crosswise extending pad support surface.

13. The device according to claim 12, further comprising said pad support being integrally formed with said stem and defining an annular positioned and interiorly open collar.

14. The device according to claim 13, said hook portion further comprising a beak shaped engaging portion, said beak portion being integrally formed with a substantially linear elongated stem in turn being coaxially seated in linearly repositionable fashion within an interior channel defined in said interiorly open collar.

15. The device according to claim 14, further comprising a plurality of exteriorly serrated surfaces exhibited upon said linear elongated stem associated with said repositionable beak shaped engaging portion, said surfaces selectively engaging inner end wall locations associated with said interiorly open collar for providing additional non-slip protection.

16. The device according to claim 14, further comprising a pair of wing tabs extending from exterior surfaces associated with said linear elongated stem, said tabs defining a maximum retracting position of said beak portion relative to the integrally formed and interiorly open collar.

17. An oral extraction device, comprising:
a handle including a stem and terminating in a hook portion for engaging a lingual surface associated with at least one of a tooth and a root tip; and
a widthwise extending pad support integrally formed with said handle via an extending neck, said pad support being repositionable relative to a downwardly angled and pointed lip associated with said hook portion and for engaging a buccal surface associated with a dental bridge supporting said tooth or root tip;
said extraction device adapted for one-handed positioned and repositioning by a user prior to and during extraction of the tooth or root lip.

18. The device according to claim 17, said pad support a base supporting and extending portion exhibiting first and second generally heightwise extending portions, in turn defining inwardly opposingly and recess extending channel defining surfaces for seating opposite front and rear surfaces associated with said stem, a slot extending lengthwise along a recessed surface defining in part said extending channel and exhibiting a lengthwise extending slot terminating in a rounded lower end and an enlarged keyhole upper end, a pin engaging through a location associated with said slot in order to secure the pad support portion to said stem.

19. The device according to claim 18, further comprising pluralities of opposing and interengaging serrations defined between said front surface of said stem and a selected one of said height extending portions of said pad support portion, said serrations providing additional non-slip protection beyond that nominally created by a fulcrum bending motion of said pad support portion against said stem.

20. The device according to claim 17, said pad support further comprising a collar shaped and interiorly open mounting component slidably engageable over said stem, said collar shaped component being linearly repositioned at locations along said stem, a spring biased pin mounted to said collar shaped component, an associated and protruding tab capable of being displaced to selectively seat and unseat said pin with respect to a selected and linearly spaced recessed mounting location defined at spaced locations along said stem.
